(19) United States
(12) Patent Application Publication
(10) Pub. No.: US 2006/0064606 A1
(43) Pub. Date: Mar. 23, 2006

(54) A METHOD AND APPARATUS FOR CONTROLLING POWER CONSUMPTION IN AN INTEGRATED CIRCUIT

(75) Inventors: Suhwan Kim, Nanuet, NY (US); Stephen V. Kosonocky, Wilton, CT (US); Peter A. Sandon, Essex Junction, VT (US)

Correspondence Address: IBM MICROELECTRONICS;INTELLECTUAL PROPERTY LAW, 1000 RIVER STREET, 972 E, ESSEX JUNCTION, VT, 05452, US

(73) Assignee: INTERNATIONAL BUSINESS MACHINES CORPORATION, Armonk, NY (US)

(21) Appl. No.: 10/711,485

(22) Filed: Sep. 21, 2004

(51) Int. Cl. G06F 1/26

(52) U.S. Cl. 713/300

(57) ABSTRACT

A method and apparatus for controlling power consumption by devices in an integrated circuit. The apparatus includes a complementary device for a corresponding device for which power consumption is desired to be reduced. The complementary device supports all or some of the tasks of the corresponding device. The complementary device receives tasks that can be executed by either itself or the corresponding device and based upon the power management scheme will either execute the task itself or allow the corresponding device.

### FIELD OF THE PRESENT INVENTION

The present invention generally relates to devices used in integrated circuits for controlling power consumption, and more specifically, to devices that manage the power and information provided to components in the integrated circuit.

### DESCRIPTION OF RELATED ART

The advances in semiconductor and computer technology have resulted in computer systems becoming exponentially faster while occupying less physical space. The consumer space of desktop, lap-top, and PDA style computer systems are now operating at processing speeds that were once exclusively reserved for main frame systems. The appetite of the consumer for ever increased speed, functionality and decreased size has challenged the technology industry to overcome perplexing issues involving power and heat.

The speed of a particular device and the amount of power consumed during its operation are currently in a monotonic relationship (i.e. the faster the device, the more power required to operate the device). Mobile devices receive their power from batteries, and although various technological improvements have been made with respect to increasing the output and life of the battery itself, the mobile devices remain particularly sensitive to conserving power while maintaining speed and functionality. Although mobile devices are the driving force for conserving power, non-mobile devices such as desktops have a vested interest as well.

It would, therefore, be a distinct advantage to have a method and apparatus for reducing the power consumption in an integrated circuit. The present invention provides such a method and apparatus.

### SUMMARY OF THE PRESENT INVENTION

The present invention controls the power consumption in an integrated circuit by controlling the power level supplied to a particular unit and the tasks handled by the unit itself. More specifically, the present invention uses a complementary unit for a corresponding unit in the integrated circuit where power consumption control is desired. The complementary unit supports all or some of the tasks executed by the corresponding unit. The complementary unit is responsible for controlling which tasks are executed by the corresponding unit or itself according to a power management scheme. Depending upon the particular power management scheme used, the complementary unit can also control the power level of the corresponding unit for tasks that the corresponding unit handles.

### BRIEF DESCRIPTION OF THE DRAWINGS

FIG. 1 is a block diagram illustrating one method used to eliminate power dissipation for an idle unit such as a processor;

FIG. 2 is a timing diagram illustrating the performance and time required by a processor to complete a given task;

FIG. 3 is a timing diagram illustrating the performance, time, and supply voltage required by a processor to complete the tasks shown in FIG. 2;

FIG. 4 is a schematic diagram illustrating a system in which a PPMU dynamically controls the powering-up and powering-down of a processor according to the teachings of a preferred embodiment of the present invention.

FIG. 5 is a flow chart illustrating the method used by the PPMU 414 for controlling the power consumption of the Processor 402 of the system of FIG. 4 according to the teachings of the present invention.

### DESCRIPTION OF THE PREFERRED EMBODIMENT

The present invention controls the power consumption in an integrated circuit by controlling the power level supplied to a particular unit and the tasks handled by the unit itself. More specifically, the present invention uses a complementary unit for a corresponding unit in the integrated circuit where power consumption control is desired. The complementary unit supports all or some of the tasks executed by the corresponding unit. The complementary unit is responsible for controlling which tasks are executed by the corresponding unit or itself according to a power management scheme. Depending upon the particular power management scheme used, the complementary unit can also control the power level of the corresponding unit for tasks that the corresponding unit handles.

The present invention uses the term Programmable Power Management Unit (PPMU) to describe a preferred embodiment of the complementary unit. It should be realized, however, that the present invention is not intended to be limited to what has been traditionally referred to as a power management unit, but to any unit that is responsible for managing the powering-up, powering-down, intercepting and processing tasks that could be processed by corresponding unit(s) under its control according to a power management scheme.

The preferred embodiment of the present invention uses the PPMU in the context of controlling a processor. It should be noted, however, that this is only a single preferred application, and that the present invention is equally applicable to other applications where the PPMU performs the functions described above.

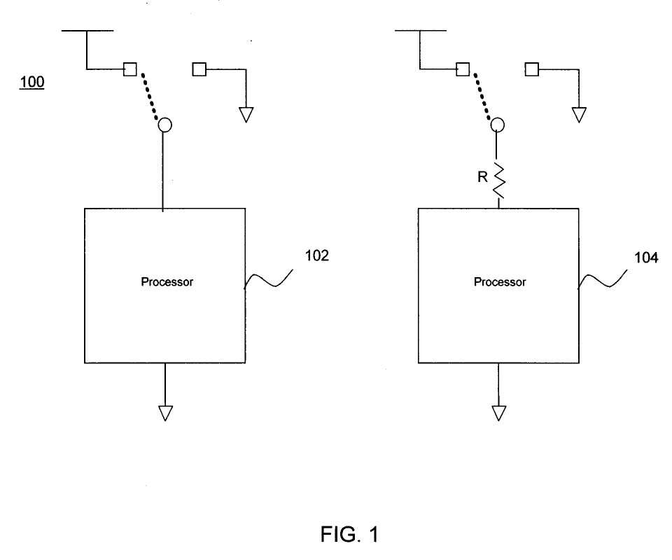

Reference now being made to FIG. 1, a block diagram is shown illustrating one method used to eliminate power dissipation for an idle unit such as a processor 100. The most effective way to eliminate power dissipation for a processor 100 or other idle unit is to turn off its power supply. Conceptually, this is a very simple operation. The operation includes inserting a switch on the power supply of the unit, and turning the switch on or off according to the power management control as noted by processor 102. The use of a switch guarantees the absolute minimum power consumption during shutdown periods.

The ideal switch depicted for processor 102 is a drastic simplification of reality. Any real switch has an associated resistance and delay. Processor 104 illustrates a more realistic model of how the power supply can be turned off. The effect of the switch resistance and of the control delay must be taken into account when evaluating the opportunity to power-off the processor 104.

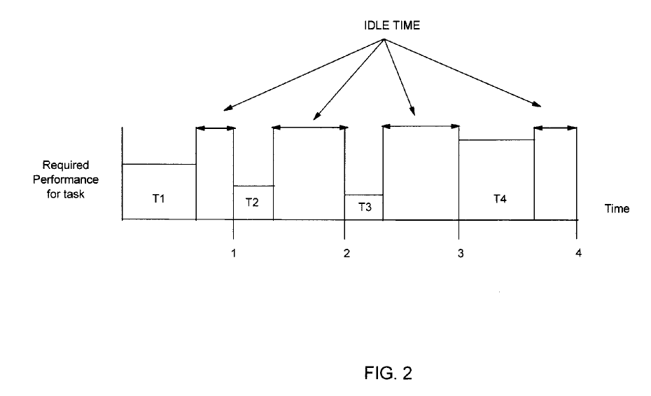

Even the processor 104 is a drastic simplification of reality. In actual circuits, a stabilized voltage supply is required. The presence of a stabilization delay limits the applicability of power-managed solutions to resources that are idle for time intervals much longer than stabilization delay. Several other difficulties including transient noise generated by turning on and off the supply voltage are involved in the power supply shutdown scheme as explained in connection with FIG. 2.

Reference now being made to FIG. 2, a timing diagram is shown illustrating the performance and time required by a processor to complete a given task. Specifically, the x-axis represents time and the y-axis represents the required performance of the processor to complete the task (1-4). In this example, four tasks are illustrated each requiring differing times for completion and performance. The time during which the processor is idle after each completion of the execution of a particular task is also noted.

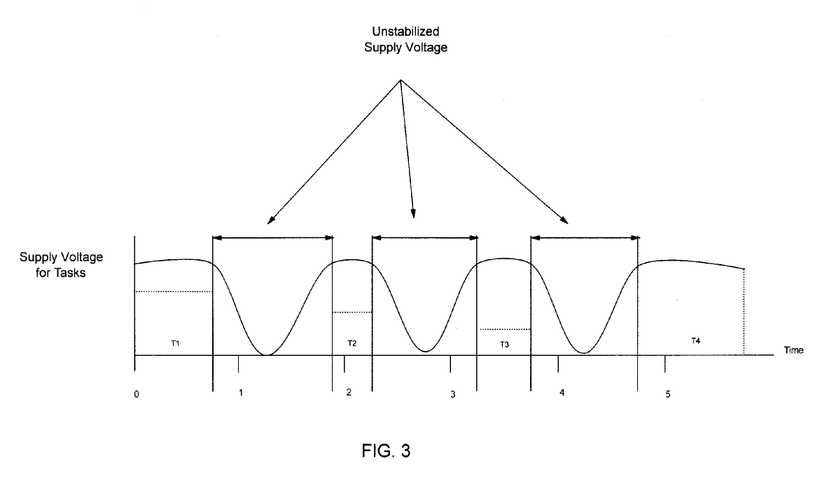

Reference now being made to FIG. 3, a timing diagram is shown illustrating the performance, time, and supply voltage required by a processor to complete the tasks shown in FIG. 2. Again, the x-axis represents time and the y-axis represents the required performance of the processor to complete the task (1-4). FIG. 3 also shows the amount of supply voltage required to complete a given task, and if the processor is idle between tasks, how much time is required to establish a stabilized voltage supply when the voltage supply shut off scheme is used. It should be noted that for the exemplary tasks 1-4 the idle time of the processor is equivalent to the amount of time required to power-up the idle processor, and therefore, no power savings are realized.

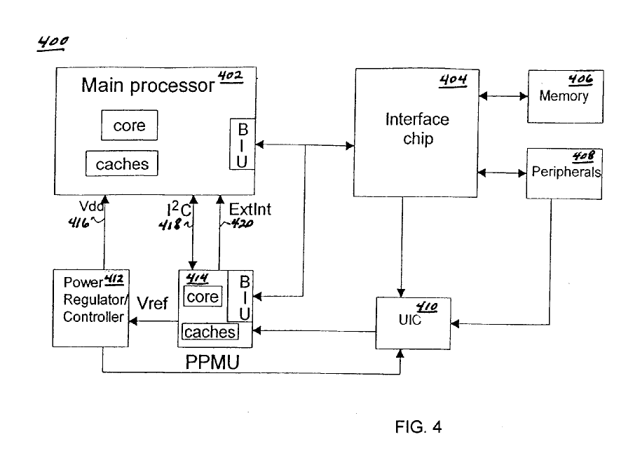

In the preferred embodiment of the present invention, the PPMU has a constant supply voltage while it controls the powering-up and powering-down of the processor. In addition, the PPMU can further enhance power reduction by having the capability to process a subset of tasks supported by the processor. With this capability, the PPMU can optimize the power management policy for each task designated for execution by the processor. In accordance with the optimized power management policy for a given task, the PPMU dynamically decides whether the task should be assigned to the processor or handled by the PPMU itself as explained in greater detail in connection with FIG. 4.

Referring now to FIG. 4, a schematic diagram is shown illustrating a system 400 in which a PPMU 414 dynamically controls the powering-up and powering-down of a processor 402 according to the teachings of a preferred embodiment of the present invention. The system includes an interface chip 404, Universal Interrupt Controller (UIC) 410, Memory 406, Peripherals 408, Main Processor 402, Power Regulator/Controller 412, and PPMU 414.

The Interface Chip 404 provides an interface to Memory 406, and peripherals 408 which can be either external or internal to the integrated circuit.

The UIC 410 controls interrupt handling and access to the Main Processor 402. In this case, the UIC 410 provides requests for interrupts directly to the PPMU to determine how they are handled. The UIC 410 also provides all external interrupt requests (e.g. Memory 406) for access to the Main Processor 402 to the PPMU 414.

The Power Regulator/Controller 412 controls the power for the powering-up and powering-down of the Main Processor 402 upon receiving appropriate commands from the PPMU 414.

Main Processor 402 includes a core, caches and a Bus Interface Unit (BIU). The use of these components is well understood, and therefore, further explanation is deemed unnecessary. The Main Processor 402 may be, for example, a PowerPC 604 produced by International Business Machines.

PPMU 414 includes a core, BUI, and caches. Again, the use of these components is well understood, and therefore, further explanation is unnecessary, except with respect to their function in connection with the preferred embodiment of the present invention as explained below.

The PPMU 414 will provide some or all of tasks supported by the Main Processor 402 depending upon the particular power saving scheme used and the design/instruction set used. The power saving scheme should be designed in such a manner so as to allow the Main Processor 402 to operate at a high level of performance during its activation, and not encumbered by the PPMU 414, and at the same time allow maximum power savings when the Main Processor 402 is inactive and only the PPMU 414 is active.

In the preferred embodiment of the present invention, the Main Processor 402 is in communication with the PPMU 414 via a chip-to-chip bus 418 such as 12C. In the preferred embodiment, the Main Processor 402 and PPMU 414 have their own internal memory caches, with capacities and organizations that are appropriate to the required power and performance demands. It should be noted that the PPMU 414 and Main Processor 402 could be implemented on the same die and share caches and the chip-to-chip bus 418 would not be required in such an embodiment.

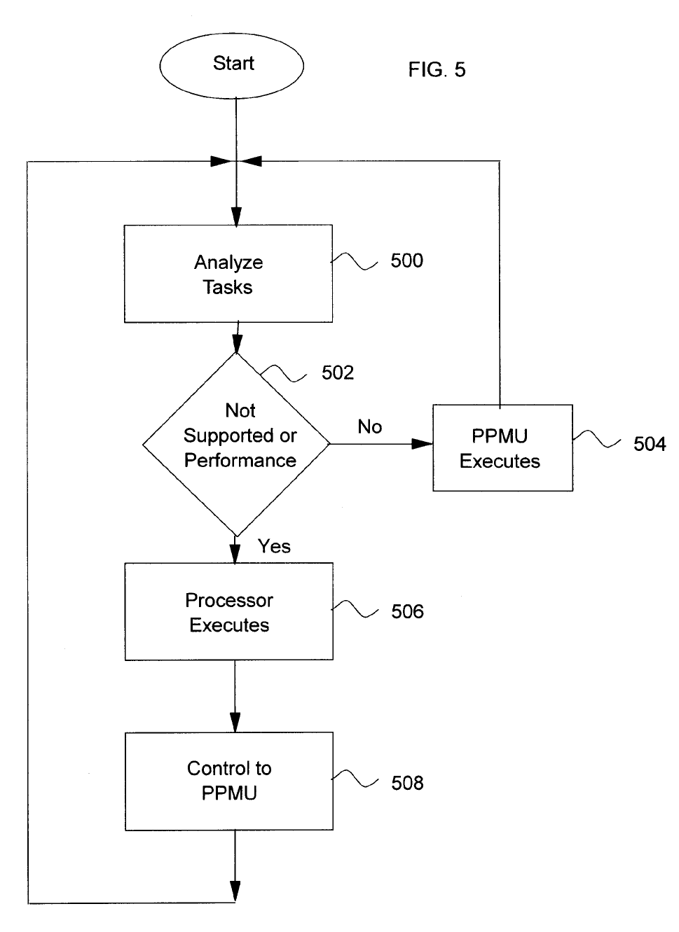

The PPMU 414 maintains control over the Processor 402 with the assistance of the Power Regulator/Controller 412, Interface Chip 404, and UIC 410. The PPMU 414 establishes the voltage level provided to power the Processor 402 via the Power Regulator/Controller 412 by providing a voltage reference level. All external interrupts are provided to the PPMU 414 via the UIC. The PPMU 414 can process the interrupt itself, if supported, or pass the interrupt to the Processor 402, waking the Processor 402 from an idle state, if necessary. The PPMU 414 can also control power management functions internal to the main processor. In example, the Processor 402 clock frequency is controlled by divider circuits in its Phase Locked Loop (PLL). The PPMU 414 can control the divider values to scale the Processor 402 frequency to dynamically match current processing requirements. In further example, if the Processor 402 supports the concept of having control over power supplied to individual components, then the PPMU 414 can also provide control over these individual components as well. The operation of the PPMU 414 in implementing a power control scheme for the Processor 402 is explained in greater detail in connection with FIG. 5.

FIG. 5 is a flow chart illustrating the method used by the PPMU 414 for controlling the power consumption of the Processor 402 of system 400 (FIG. 4) according to the teachings of the present invention. The PPMU 414 analyzes the properties of each task that is directed towards the Processor 402 to determine whether the task is supported by itself or requires higher performance than it can provide (Step 500). If the task is supported by the PPMU 414 and does not require a performance level that exceeds that which the PPMU 414 can provide (Step 502), then the PPMU 414 executes the task (Step 504). The PPMU 414 then continues to analyze tasks as previously stated (step 500).

If, however, the task is not supported by the PPMU 414 or requires a performance that exceeds that which the PPMU 414 is capable of providing (Step 502), then the PPMU 414 powers-up the Processor 402 and passes the task for execution (Step 506). The powering-up of Processor 402 is accomplished by having the PPMU 414 execute a predetermined sequence. The sequence includes raising the power supplied to the Processor 402 to a level required for execution of the received task by providing a reference voltage to the Power Regulator/Controller 412. For example, if the header devices on the Processor 402 have been turned off to block certain internal portions, then the PPMU 402 activates these devices. Using a timing loop or detection circuit, the PPMU 414 waits for or monitors the voltage until it reaches its desired level (e.g. an interrupt from the Power Regulator/Controller 412).

The sequence includes setting the state of the Processor 402 to some minimal level to allow bootstrapping itself to an active state. This can be accomplished in several different ways. One such way, is saving most of the required state on the Operating System (OS) memory stack, and forcing an interrupt in the Processor 402 whose handler restores the Processor 402 state from the stack. The stack location itself can reside in a register that the PPMU 414 can access or some other known location.

The sequence continues with the PPMU 414 ungating the clocks to the Processor 402 which takes the interrupt, boots up its machine state, and begins executing the application code. It should be noted that while the Processor 402 is executing the task, the PPMU 414 suspends its own execution of the main thread, but can execute maintenance code, and continue to provide other services. For example, the PPMU 414 can snoop the bus to maintain the coherency of its caches.

After the task has been executed by the Processor 402 at the performance level set by the PPMU 414, the Processor 402 returns control to the PPMU 414 (Step 508). This is accomplished by the Processor 402 flushing its caches and disabling them so that the array voltage can be reduced to a retention level or turned off completely. Alternatively, by continuing to run the snoop logic on the cache tag arrays, the state of those caches could be maintained. The Processor 402 continues by saving its state on the OS stack, and sets a bit in a register that signals the PPMU 414. The PPMU 414 gates the clocks to the Processor 402, and begins executing the main thread starting from a known address, such as an interrupt vector. The PPMU 414 restores its own state, and continues to analyze tasks as stated above (Step 500).

It is thus believed that the operation and construction of the present invention will be apparent from the description provided. While the method and apparatus shown and described has been characterized as being preferred, it will be readily apparent that various changes and/or modifications can be made wherein without departing from the spirit and scope of the present invention as defined in the claims.

What is claimed is:

1. An apparatus comprising:
a communication device capable of communicating tasks requiring execution;
a designated unit capable of processing the communicated tasks
a power regulator capable of regulating the power supplied to the designated unit;
a complementary unit capable of receiving the communicated tasks, executing the communicated tasks either itself or providing the communicated tasks to the designated unit for execution while ensuring that the power supplied to the designated unit is consistent with that required to execute the communicated task via the power regulator.

2. The apparatus of claim 1 wherein the designated unit includes at least one internal unit capable of having its clock speed adjusted, and the complementary unit further includes:
circuits capable of controlling the clock speed of the at least one internal unit for desired performance requirements.

3. The apparatus of claim 1 wherein the designated unit includes at least one voltage controllable unit, and the complementary unit further includes:
voltage controlling circuitry capable of controlling the voltage supplied to the at least one voltage controllable unit.

4. The apparatus of claim 1 wherein the communication device includes a universal interrupt controller capable of communicating tasks supported by the designated unit that are ready for execution.

5. The apparatus of claim 4 wherein the complementary unit includes:
power controlling circuitry capable of powering-up and powering-down the designated unit using the power regulator.

6. The apparatus of claim 5 wherein the designated unit includes at least one internal unit capable of having its clock speed adjusted, the complementary unit further including:
circuits capable of controlling the clock speed of the at least one internal unit for desired performance and power requirements.

7. The apparatus of claim 6 wherein the designated unit includes at least one voltage controllable unit, and the complementary unit further includes:
voltage controlling circuitry capable of controlling the voltage supplied to the at least one voltage controllable unit.

8. The apparatus of claim 7 wherein the communication device includes a universal interrupt controller capable of communicating tasks supported by the designated unit that are ready for execution.

9. The apparatus of claim 8 wherein the complementary unit is capable of executing a subset of the communicated tasks.

10. The apparatus of claim 9 wherein the complementary unit is capable of executing all of the communicated tasks.

11. A method of controlling power consumption in an integrated circuit, the method comprising the steps of:
communicating tasks for execution;
creating a designated unit capable of processing the communicated tasks;
creating a complementary unit for the designated unit, the complementary unit receiving the tasks and either executing the communicated tasks itself or providing the communicated tasks to the designated unit for execution.

12. The method of claim 11 further comprising the steps of:
receiving a communicated task with the complementary unit; and
selecting, using the complementary unit, the task for execution by the complementary unit or the designated unit depending upon on which selection will save power.

13. The method of claim 12 wherein the step of selecting includes:
selecting the complementary unit for executing the communicated task.

14. The method of claim 13 further comprising the step of:
powering down the designated unit.

15. The method of claim 12 wherein the step of selecting includes:
selecting the designated unit for executing the communicated task.

16. The method of claim 15 further comprising the step of:
powering up the designated unit.

17. An integrated circuit comprising:
a designated unit capable of executing a set of tasks;
a complementary unit capable of selecting either itself or the designated unit for execution of a received task, the complementary unit using less power than the designated unit would for execution of the same task.

18. The integrated circuit of claim 17 wherein the complementary unit includes:
a power controlling unit capable of powering up and powering down the designated unit depending upon its selection for execution of tasks.

19. The integrated circuit of claim 18 wherein the designated unit includes:
voltage controllable circuitry capable of having its power or voltage level lowered or turned off.

20. The integrated circuit of claim 19 wherein the power controlling unit includes the ability to control the voltage controllable circuitry in order to save power.

21. The integrated circuit of claim 20 wherein the power controlling unit controls the power supplied to the voltage controllable circuitry during the execution of a particular task in order to save power.
